(19) United States
(12) Patent Application Publication
(10) Pub. No.: US 2021/0204575 A1
(43) Pub. Date: Jul. 8, 2021

(54) FOOD PRODUCT HAVING FLAVOR-ACTIVE SUBSTANCE MADE FROM RAW MATERIALS OF ANIMAL ORIGIN OR FROM EXTRACTS OF SAME

(71) Applicants: The Family Butchers Nortrup GmbH & Co. KG, Nortrup (DE); DIL Deutsches Institut für Lebensmitteltechnik e.V., Quakenbrück (DE)

(72) Inventors: Wolfgang KÜHNL, Quakenbrück (DE); Thomas WINNEMÖLLER, Kluse (DE); Christian HERTEL, Quakenbrück (DE); Dirk STEINRIEDE, Damme (DE)

(73) Assignees: The Family Butchers Nortrup GmbH & Co. KG, Nortrup (DE); DIL Deutsches Institut für Lebensmitteltechnik e.V., Quakenbrück (DE)

(21) Appl. No.: 17/057,259

(22) PCT Filed: May 23, 2019
(86) PCT No.: PCT/EP2019/063384

§ 371 Date: Nov. 20, 2020

(30) Foreign Application Priority Data
May 23, 2018 (DE) 10 2018 112 348.5

(51) Int. Cl. A23L 13/40; A23L 13/60

(52) U.S. Cl. CPC A23L 13/46; A23L 13/65; A23L 13/428

(57) ABSTRACT

The invention relates to a food, especially a meat product, containing a specific taste-active substance, to the use of raw materials of meat, or of extracts of such raw materials of meat, as taste-active substance, and to a method for producing a food containing a taste-active substance, especially a meat product containing taste carriers. Here, the invention relates to those foods, especially meat products, selected from the group consisting of meat preparation, uncooked sausage, scalded sausage, cooked sausage, cooked cured article, uncooked cured article, aspic and jellied meat, which contain (i) at least partially fermented meat, or (ii) an extract of at least partially fermented meat, as taste-active substance in the food.

The invention relates to a food, especially a meat product, containing specific taste-active substances, to the use of raw materials of meat, or of extracts of such raw materials of meat, as taste-active substance, and to a method for producing a food containing a taste-active substance, especially meat product containing a taste-active substance.

Foods are a consolidating name for substances which serve for human nutrition. In the prior art, foods therefore include all substances which are intended to be ingested by humans in a raw, prepared, treated or processed state for the purpose of nutrition or indulgence. In the prior art, foods also include food ingredients, food additives and food supplements. Foods are classified according to categories, in general especially according to the main constituent of a food into the following products and product groups: cereals and cereal products; potatoes and potato products; fruit, fruit products and dried fruit; vegetables and legumes; nuts and seeds; meat and meat articles/meat products; fish and fish products; milk and milk products; eggs and egg dishes; oils and fats; confectionery articles and sugar; preserves; ready meals; sauces and condiments; spices and herbs; alcohol-free beverages; and alcoholic beverages.

The expression “taste” is understood by a person skilled in the art to mean a sensory perception, i.e., a chemical sense like smell. Taste is perceived on the tongue via taste buds which lie in papillae and have chemically sensitive cells. It being possible for the taste buds to contain cells for differing taste. Taste is also referred to as gustatory sense.

Gustatory perception refers to the subjectively experienced event of taste sensations caused by stimulation of specific sensory organs of taste, such as the taste buds.

Olfactory perception, also called smell perception, sense of smell or olfactory sense, is the perception of odors. Various sensory systems can be involved in olfactory perception: not only the actual olfactory system (olfactory stimuli), but also the nasal/trigeminal system (tactile and chemical stimuli) and influences of the gustatory system (taste stimuli). The sense of smell is the most complex chemical sense. The odor sensory cells are provided with specific odor receptors and generally located in the nose in vertebrates.

Taste is therefore understood by a person skilled in the art to mean a complex sensory impression during ingestion of food that arises from the multimodal interplay of sense of smell and sense of taste as well as sense of touch, sensation of temperature and sensation of pain. In many cases, the sensations based on a food, within this meaning as “taste”, primarily come about through flavors which are perceived by the sense of smell and less through stimuli within the oral cavity.

The sense of taste is, just like the sense of smell, activated by chemical stimuli, but is a proximity sense by means of which ingested food can be checked before actual intake. In adult humans, the sensory cells of the taste organ lie in the glossal and pharyngeal mucosa and mediate five (or six) basic qualities. Acidic and bitter taste can indicate unripe, fermented or poisonous foodstuffs. The taste qualities salty, sweet, umami (and fatty) characterize a food roughly according to its content of minerals and nutritionally important substances such as carbohydrates, proteins and fats.

Carriers or else carrier substances are understood by a person skilled in the art to mean those substances which have the ability to bind other substances physically, for example by adsorption. At the same time, the carriers or the carrier substances alone generally do not alter the taste and/or the appearance of a food, but they can contribute to influencing, for example modifying, enhancing, attenuating and/or improving, the taste of a food via the binding of, for example, flavorings (taste-producing substances) or even the appearance thereof via the binding of possibly other substances.

Carriers or else carrier substances are therefore substances which help to distribute other substances such as, for example, colorants, flavorings or vitamins in a food in a controlled manner. Carriers themselves have no technological effect within the product, but facilitate the use and the handling of food additives and other substances used for industrial food production. Since carriers themselves exhibit no effect in the end product, they are considered to be technical auxiliaries. As such, carriers need not be indicated in the list of ingredients, but are a discrete functional class within the food additives.

Additives for foods must first be authorized by the EU before they are allowed to be used for food production. If a carrier is authorized, then it is allowed to be used by the food industry. In general, additives are only authorized for certain foods up to a certain maximum quantity. This also applies to carrier substances. However, carriers are exempt from the declaration requirement on food packaging. They have no technical effect in the end product and are therefore classified under auxiliaries.

Carriers or else carrier substances for foods are generally subject to a legal authorization and declaration requirement and are identified by so-called E numbers like other additives. Examples of carriers authorized in the EU include: potassium acetate (E 261), sodium acetate (E 262), calcium acetate (E 263), soybean polyose (E 426), beta-cyclodextrin (E 459), ethylcellulose (E 462), methylethylcellulose (E 465), sodium carboxymethylcellulose (E 466), magnesium salts of fatty acids (E 470 b), acetic acid esters of mono- and diglycerides of fatty acids (E 472 a), lactic acid esters of mono- and diglycerides of fatty acids (E 472 b), citric acid esters of mono- and diglycerides of fatty acids (E 472 c), tartaric acid esters of mono- and diglycerides of fatty acids (E 472 d), sodium carbonates (E 500), potassium carbonates (E 501), magnesium carbonates (E 504), magnesium chloride (E 511), sodium sulfates (E 514), potassium sulfates (E 515), calcium sulfates (E 516), ammonium sulfates (E 517), silicon dioxide (E 551), calcium silicate (E 552), magnesium silicate (E 553 a), talc (E 553 b), aluminum silicate (E 559), fatty acids (E 570), beeswax (E 901), maltitol (E 965), polyvinylpyrrolidone (E 1201), polyvinylpolypyrrolidone (E 1202), oxidized starch (E 1404), monostarch phosphate (E 1410), distarch phosphate (E 1412), phosphated distarch phosphate (E 1413), acetylated distarch phosphate (E 1414), acetylated starch (E 1420), acetylated distarch adipate (E 1422), starch sodium octenyl succinate (E 1450), triethyl citrate (E 1505), glyceryl diacetate (E 1517), glyceryl triacetate (E 1518), benzyl alcohol (E 1519), propylene glycol (E 1520).

In the prior art, a major role is played in the production of foods by, inter alia, fermentation processes or fermentative methods in the production and preservation of foods.

Furthermore, flavorings develop or tannins, such as, for example, in the case of tea, cocoa, coffee and tobacco, are degraded. Furthermore, fermentation processes or fermentative methods are used in the production of dairy products, such as cheese or yoghurt, or the production of tofu or uncooked sausage (e.g., salami).

It is therefore an object of the invention to provide foods, the taste of which is modified and/or improved with the aid of raw materials and/or extracts thereof that are as natural as possible; in particular, the foods should convey additional taste notes, preferably nutty, yeasty and/or cheesy taste notes. It is also an object of the invention to specify corresponding uses of raw materials and/or extracts thereof that are as natural as possible and also to specify corresponding methods for producing such foods.

This object is achieved by the food, especially meat product, specified in the claims, comprising (i) at least partially fermented meat, or (ii) an extract of at least partially fermented meat, as taste-active substance in the food, wherein (i) the at least partially fermented meat or (ii) the extract of the at least partially meat of animal origin can have reached the other constituents of the food only by addition to the food and is preferably distributed across the entire cross-section of the food, wherein the at least partial fermentation is carried out under at least partially aerobic conditions. The object is also achieved by the use, as specified in the claims, of (i) at least partially fermented meat, or (ii) an extract of at least partially fermented meat, as taste-active substance in a food and by the method, as specified in the claims, for producing a food according to the invention.

It is preferred that the fermentation is carried out under conditions at which moisture is withdrawn from the meat to be fermented.

Foods in the context of the present invention are, for example, inherently all foods which allow fermentative treatment and/or fermentative additives or especially in which they are desired. In particular, foods in the context of the present invention encompass, for example, dairy products, cheese and processed cheese preparations, bread and bread additives, baked articles, fillings for baked articles, ready meals, semi-ready meals, frozen products, desserts, soups, sauces, cereal products, and preferably meat products. Here, preferred foods are meat products selected from the group consisting of meat preparation, uncooked sausage, scalded sausage, cooked sausage, cooked cured article, uncooked cured article, aspic and jellied meat.

Preferably, the invention relates to a food, especially meat product, selected from the group consisting of meat preparation, uncooked sausage, scalded sausage, cooked sausage, cooked cured article, uncooked cured article, aspic and jellied meat, comprising (i) at least partially fermented meat, or (ii) an extract of at least partially fermented meat, as taste-active substance in the food, wherein (i) the at least partially fermented meat or (ii) the extract of the at least partially fermented meat can have reached the other constituents of the food only by addition to the food and is preferably distributed across the entire cross-section of the food.

The fundamental production of the foods according to the invention, especially the meat products according to the invention, including the preferred meat product selected from the group consisting of meat preparation, uncooked sausage, scalded sausage, cooked sausage, cooked cured article, uncooked cured article, aspic and jellied meat, can be carried out according to the methods and recipes known per se to a person skilled in the art, though, according to the invention, the production at least one or more steps for adding at least one or more of the (i) at least partially fermented meat or (ii) extract of at least partially fermented meat as taste-active substance, as proposed according to the invention, to the other constituents of the food, with the result that the taste-active substance can have come only by addition to the food and is preferably distributed across the entire cross-section of the food.

In connection with the invention, the expression “cross-section of the food” encompasses and/or means a distribution of the taste-active substance across the food that is as uniform as possible, preferably a homogeneous distribution, meaning that the taste-active substance can be found especially with maximum uniform distribution in any sections or cross-sections taken from the food. This means that the invention differs from other foods in which the production thereof may involve fermentative methods taking place only on the surface, such as, for example, in the case of provision of edible mold on the surface of salami. The invention therefore significantly differs from the prior art in that it is not just a mere, subsequent and/or superficial provision of edible mold for an already produced food, for example by maturation, which takes place, but that at least partially fermented meat, or an extract of same, as taste-active substance is already added during the production of the food to the other constituents of the food and processed and further processed therewith. The introduction into the food means that the product characteristics (e.g., due to the cross-sectional distribution in the food) distinctly differ from prior-art products in which only a mere, subsequent and/or superficial provision of edible mold takes place.

According to the invention, the fermentation is carried out at least partially under aerobic conditions. Fermentation in the context of this text always takes place under the influence of microorganisms which were preferably actively added. Since the conditions under which the fermentation in the context of the present invention takes place are at least partially aerobic, the microorganisms used must be at least oxygen-tolerant, i.e., be facultatively aerobic, but in many cases it may be preferable to use obligately aerobic microorganisms.

The taste-active substance according to the invention can be detected by microbiological analysis on the product and/or intermediate products. Here, the microorganisms used for the fermentation and still present, alive and/or killed, in the food and/or the characteristic constituents thereof (e.g., proteins, DNA, RNA) are determined at least qualitatively, but also quantitatively if necessary, in methods customary for a person skilled in the art in food technology and food analysis.

In relation to the prior art, the present invention has the advantage that a natural taste can be produced with natural raw materials, which moreover do not require authorization. As a result of the invention, it is therefore possible to give the foods a pleasant natural taste, which is enhanced and/or intensified if desired, and moreover possible to reduce and/or, if necessary, avoid the use of additives and of salt, especially of table salt.

The designations of foods, including meat products, and possibly also of raw materials in this connection as well as processing products and intermediate products and the like may be subject to linguistic, regional, cultural and/or country-specific differences and/or nuances and to differences and/or nuances of these kinds. It is therefore clarified that the terms or expressions used in the context of the present invention are, in terms of their meaning, used as customarily understood by a person skilled in the art. A person skilled in the art is, at the same time, also capable of appropriately adapting linguistic, regional, cultural and/or country-specific nuances of the terms or expressions used here, in terms of their conceptual and/or technical meaning, in line with the understanding of the present invention. For better understanding of terms or expressions in line with the invention, the terms or expressions used here to describe the present invention shall therefore be specified and elucidated below.

The expression “taste-active substance” means that the thus identified substance has a taste-altering function in the context of the present text. In other words, a relevant substance only acts as a “taste-active substance” when it, by means of the customary tests, in case of doubt by means of a pendulum test as described further below, has an effect in the end product by verifiably proving to be taste-altering compared to a product, the composition of which is identical to the product to be tested with the exception of the absence of the (potentially) taste-active substance. In this connection, examples of relevant taste alterations are enhancement or attenuation of one or more taste notes, masking of one or more taste notes or addition of one or more taste notes, and what is last mentioned is preferred in the context of the present invention.

In connection with the invention, the expression “food” encompasses and/or means substances which are consumed in order to nourish the human body. The term food therefore also encompasses foodstuffs as an umbrella term. In contrast to drinking water, foodstuffs essentially consist of macronutrients, such as carbohydrates, lipids (fats) and proteins. In addition, micronutrients are essential constituents of foodstuffs as macroelements and trace elements.

In connection with the invention, the expression “food additive” encompasses and/or means all substances, including water, which are intentionally added to the food during its production or treatment and/or processing.

In connection with the invention, the expression “meat” encompasses and/or means, in line with the applicable Leitsätze für Fleisch and Fleischerzeugnisse (Guidelines for meat and meat products), all parts of slaughtered or shot warm-blooded animals intended for human consumption. Thus, the expression “meat” does not encompass poikilothermic animals, such as, for example, fishes, crabs, mussels and snails, the soft parts of which are used as foodstuffs and for which the expression “meat” in the broader sense is also used in general language to refer to the soft parts thereof as foodstuffs. Therefore, the expression “meat” does not encompass and/or mean aquatic animal meat. In connection with the invention, the expression “meat” expressly does not encompass and/or mean mechanically separated meat and it also expressly does not encompass and/or mean offal. In connection with the invention, the expression “meat product” therefore encompasses and/or means a product comprising or consisting of meat. In connection with the invention, the expression “meat preparation” therefore encompasses and/or means any preparation which comprises or consists of meat and/or any preparation in which meat is used and/or added.

In connection with the invention, the expression “sausage” encompasses and/or means a foodstuff which is usually prepared from minced meat, bacon, salt and spices, including use of blood and offal in certain varieties. The prepared mass, the sausage meat, is filled into intestines, bladders or stomachs, divided into individual sausages by tying off with sausage thread or clipping off with rust-free metal clips, and, depending on the variety, cooked by boiling or baking or preserved by drying with or without additional smoking. Artificial sausage skins, jars and tins are also used in sausage production. Sausage is produced by mincing meat (especially from pig, cattle and calf, additionally also from lamb, poultry (poultry sausage), horse and game) and bacon using a grinder and mixing them with the spices. In the case of fine sausages, the mass is additionally processed with a cutter, with addition of ice, to form a homogeneous paste.

Sausage varieties are divided into three groups according to the methods of production: uncooked sausage, scalded sausage and cooked sausage.

In connection with the invention, the expression “uncooked sausage” encompasses and/or means a sausage variety, the basis of which is formed by uncooked, i.e., unheated, meat. Uncooked sausage consists of uncooked meat, bacon and spices and is either freshly consumed or preserved by drying and/or smoking. Smoking is preceded by a maturation process in which the sausage reddens and develops its consistency and its flavor. Lactic acid bacteria and Staphylococci or Micrococci, and sometimes also yeast or edible mold, are additionally involved in the maturation process. Uncooked sausages are divided into spreadable and cuttable uncooked sausages. Typical spreadable uncooked sausages are the nonmatured or only briefly matured Mettwurst and Teewurst. Typical cuttable uncooked sausages are the longer matured, hard dry sausages such as Ahle Wurst, chorizo, Landjäger, salami, Walliser Trockenwurst and Zervelatwurst.

In connection with the invention, the expression “scalded sausage” encompasses and/or means a collective name for sausage varieties, the production of which involves first completely or partially comminuting uncooked meat with addition of water or ice and then completely or partially coagulating the muscle protein by a heat treatment (scalding, roasting, baking or in some other way). This yields a firm structure which makes the sausage cuttable. The scalded sausage therefore differs from an uncooked sausage, in the case of which the sausage meat is not coagulated by the action of heat, and also from the cooked sausage, in the case of which the majority of the sausage meat is already cooked before sausage-making.

Scalded sausage is usually produced from very fine sausage meat, in many cases with the addition of curing salt. Water or ice is added to the sausage meat, and, after possible hot-smoking, the sausages are scalded or are baked at a moderate temperature. Insets such as diced bacon or ham can also be added to the sausage meat. Frankfurter and Wiener, Mortadella, Lyoner (Fleischwurst) and Weisswurst are known scalded sausages. In the broader sense, the scalded sausages also include Leberkäse. Scalded sausages are divided into small scalded sausages (diameter under 32 mm), finely minced scalded sausages (Fleischwurst, Lyoner), coarse scalded sausage (Bierwurst, Jagdwurst) and scalded sausage containing insets, such as Bierschinken.

In connection with the invention, the expression “cooked sausage” encompasses and/or means a collective name for sausage varieties, the majority of the ingredients of which were cooked before processing to yield the sausage mass. Binding between the individual constituents is achieved by solidified fat (sausage spreads), jelly (jellied meat) or by heat-coagulated blood protein (blood sausage). In contrast to scalded sausages, cooked sausages therefore do not remain cuttable upon heating, but more or less melt. After filling into intestines, jars or tins, cooked sausage is cooked through again as a whole in hot water or steam. In addition to meat, cooked sausage commonly also contains offal such as liver or tongue, blood and, in the case of Grützwurst, even cereal. Since the ingredients spoil quickly and cooked sausage also usually does not have a long shelf life, it was traditionally produced on days of slaughter and is therefore a permanent fixture of Schlachtplatte.

Cooked sausage is predominately produced from ingredients which have already been cooked. The proportion of uncooked ingredients can dominate only when liver, bacon or blood predominate. Cooked sausages gain their binding via coagulated liver protein and owing to the fat which solidifies upon cooling (applicable in the case of liverwursts), owing to the jelly or collagen which solidifies upon cooling (applicable in the case of jellied sausages) or owing to the coagulated blood protein and to the collagen which escapes from the pork rind and solidifies upon cooling (applicable in the case of blood sausages). After filling, cooked sausages are cooked again, and sometimes also smoked. The cooked sausages include all blood sausages and liverwursts and jellied sausages, such as Kalbsleberwurst, Rotwurst, Grutzwurst, Presskopf, corned beef, Schwartenmagen, Pfalzer Saumagen and haggis.

In connection with the invention, the expression “sausage filling”, “sausage stuffing”, “sausage meat” and the like encompasses and/or means, in line with the applicable Leitsätze für Fleisch and Fleischerzeugnisse (Guidelines for meat and meat products), a meat which is uncooked and has been minced with the addition of (drinking) water and/or salts. In connection with the invention, the expression “sausage meat-type structures” encompasses and/or means those structures arising in the mechanical treatment of meat. Said mechanical treatment of meat involves the destruction by friction of muscle cells, from which proteins escape. The proteins which have escaped form, together with salts and/or water, structures histologically similar to the above-described sausage meat.

The invention also encompasses “cooked cured article” and “uncooked cured article”. Here, in connection with the invention, the expression “curing” encompasses and/or means a treatment of meat articles and sausage articles with table salt and with sodium or potassium salts of nitric acid (sodium or potassium nitrate) or of nitrous acid (sodium or potassium nitrite), the so-called curing agents. Optionally, further curing auxiliaries such as, for example, ascorbic acid, sugar types and glucono delta-lactone, and also spices, are added. Curing thus requires the use of curing agents and therefore does not encompass mere salting, which does not use curing agents. The vast majority of products subjected to one-piece curing are pork; in addition, beef and veal is also cured to a lesser extent. In the case of products composed of minced meat, the proportion of beef is higher.

The purpose of curing is to protect the article from microbial spoilage and to preserve it, to alter the red color of meat and to make it heat-resistant, this being referred to as so-called “reddening”, and to give the article a characteristic flavor. The preservation only works against some bacteria, and even then only to a limited extent; nowadays, it is no longer paramount in comparison with color and flavor development. Nevertheless, it ultimately contributes toward producing nonperishable foods in cooperation with further preservation measures such as drying, smoking and heating. The reddening, the curing flavor and also the inhibition of bacterial growth, to the extent that it goes beyond the very limited action of pure salting, are solely caused by the nitrite, and not by the nitrate. Nitrate curing is possible because nitrate is enzymatically reduced by certain microorganisms to form nitrite. Nitrate curing thus only works when the curing material can mature for a sufficiently long time without heating so that a curing flora can develop.

“Cooked cured article” differs from “uncooked cured article” in that a cooking process is involved in the creation of the relevant article. In this connection, said cooking process is designed such that a temperature at which the meat proteins are denatured is reached. In case of doubt, said temperature is at least 50° C.

Here, in connection with the invention, the expression “article”, on its own and as part of an expression, is to be understood as synonymous with the expression “product”, “variety” and the like, and also encompasses and/or means articles in the sense of a commodity which is the subject of trade in goods, manufacture of goods and the like.

The expressions “aspic” and “jellied meat” shall be elucidated below in connection with the invention, though these expressions in practice may be partially overlapping designations for foodstuff preparations.

In connection with the invention, the expression “aspic” encompasses and/or means a foodstuff as a jelly produced from meat, and it is especially a meat jelly made from meat broth (aspic). The expression “aspic” can, at the same time, also encompass and/or mean cold, salty preparations made from different foods, usually prepared separately beforehand, that are covered with jelly, and wherein some of these preparations are subsumed under the collective name “jellied meat”. Here, the expression “jelly” refers to foods having a gelatinous consistency, which can be produced in many ways. Meat jelly made from meat broth (aspic) is, for example, used for jellied meats, for glazing and for sauce thickening, fruit jelly made from fruit juice for preserves and desserts. Chemically, these substances are gels.

In connection with the invention, the expression “jellied meat” encompasses and/or means a foodstuff as a cold preparation made from meat, also containing vegetables if desired, that is set into jelly. In connection with the invention, the expression “jellied meat” also encompasses and/or means in the broadest sense so-called jellied sausages. Another designation therefor is the respective foodstuff in aspic. The jellied sausage belongs to the group of the cooked sausages. It generally consists of precured and precooked meat. After filling, the sausage is scalded again and gains its cuttability owing to the jelly mass which solidifies upon cooling (gel). This is added to the product in the form of liquid-dissolved food gelatin or aspic powder (e.g., in the case of jellied meats) or forms directly in the product when processing minced pork rind as cloudy aspic (e.g., in the case of Presswurst). Upon reheating, jellied sausages lose their firm consistency.

The expression “broth” encompasses and/or means a liquid preparation which is cooked from at least one constituent selected from meat, bone, vegetables and, if desired, further ingredients with water and which, for example, is also referred to as “(clear) soup”.

As an alternative to the expression “broth”, the following synonyms are, inter alia, also common: meat broth, vigorous broth, bouillon, consommé. Here, the expression “meat broth” encompasses and/or means a broth obtained by boiling meat and bone. Here, the expression “vigorous broth” encompasses and/or means a vigorous meat broth, i.e., for example a meat broth having an increased content of boiled constituents and ingredients. Here, the expression “bouillon” encompasses and/or means a meat broth obtained by boiling meat, bone and soup vegetables, possibly also as “vigorous boullion” having an increased content of boiled constituents and ingredients. Here, the expression “consommé” encompasses and/or means a vigorous broth made from beef and soup vegetables.

The expression “fish broth” encompasses and/or means a corresponding broth which is, however, produced from fish instead of from meat.

The expression “poultry broth” encompasses and/or means a broth which must likewise be produced correspondingly, but with use of poultry meat, rawly eviscerated poultry and/or extract from poultry meat.

A liquid preparation referred to as “broth” serves, for example, as a base for soups and sauces and as a cooking liquid for meat, poultry, fish and vegetables and can usually be obtained as follows:
(a) By boiling of suitable protein-rich substances or their extracts and/or hydrolysates with water with or without addition of condiments and/or odorous and taste-producing substances, cooking fats, table salt, spices and their natural extracts and distillates or other foods and/or food additives for the purpose of improving their taste and such additives. The substances present therein get into the liquid by osmosis in this process.
(b) By reconstitution, i.e., mixing with liquid, especially with water, of an equivalent mixture of solid, dried, for example freeze-dried, ingredients as described under (a) according to instructions. Said solid, dried mixtures can be present as powder, granular material, pellets, pressed products, such as, for example, cubes, tablets, bars, slabs and the like.
(c) By dilution or mixing with liquid, especially with water, of an equivalent mixture, as described under (a), in concentrated form still containing liquid, especially water, for example as a thick, thickened, pasty and/or viscous liquid, syrup, gel and/or paste, present.

Furthermore, it should be explained that such a liquid preparation referred to as “broth” is called a (clear) soup in Austria and bouillon in Switzerland. Especially in the culinary language of the Federal Republic of Germany, the expression “broth” refers to water enriched by foods cooked therein that contain flavorings, minerals and fats. Broth serves as a base for soups and sauces and as a cooking liquid for meat, poultry, fish and vegetables. Foods cooked in broth remain more flavorful, since the broth already contains taste-producing substances and minerals which pass into the cooked material in part, instead of withdrawing these substances therefrom. Depending on the intended use, a broth is produced by using vegetables, bone, meat, poultry or fish, including in combinations. The substances present therein get into the liquid by osmosis in this process. So that a broth becomes particularly flavorful, the ingredients should already be added to cold water and be salted only toward the end of the cooking time—in this way, the osmotic gradient is particularly high and more substances diffuse into the water. To protect volatile flavorings, broths are not cooked at a rolling boil, but only heated exactly to the boiling point.

For illustration, exemplary compositions of meat broth, meat consommé, poultry broth and other broths shall be specified here as “broth” compositions.

For example, a meat broth usually contains a proportion of meat, expressed as fresh meat, of, for example, not less than about 10 g or a proportion of meat extract of, for example, not less than 0.67 g, and, in each case, table salt in a quantity of, for example, not more than 12.5 g, based on a volume of 1 liter.

For example, a meat consommé usually contains a proportion of meat, expressed as fresh meat, of, for example, not less than about 15 g or a proportion of meat extract of, for example, not less than 1 g, and, in each case, table salt in a quantity of, for example, not more than 12.5 g, based on a volume of 1 liter.

For example, a poultry broth produced using poultry meat, rawly eviscerated poultry and/or extract from poultry meat must usually contain a content of total nitrogen of, for example, not less than 100 mg and table salt in a quantity of, for example, not more than 12.5 g, based on a volume of 1 liter.

For example, other broths must usually contain a content of total nitrogen of, for example, not less than 200 mg, of amino nitrogen of, for example, not less than 120 mg, table salt in a quantity of, for example, not more than 12.5 g, based on a volume of 1 liter.

“Broth” is usually available in various supplied formats, such as, for example, ready-to-consume broths and consommés, thickened and concentrated broths and consommés, and also dried broths and consommés.

Ready-to-consume broths and/or consommés are understood by a person skilled in the art to mean products intended for consumption in the supplied form with or without heating.

Thickened and/or concentrated broths and/or consommés are understood by a person skilled in the art to mean liquid, thick or pasty products which, after addition of water as per instructions, yield preparations corresponding to the definitions and modes of production specified above for the expressions “broth” and “consommé”; see, for example, especially (a) and (c)).

Dried broths and/or consommés are understood by a person skilled in the art to mean products which, after reconstitution with water as per instructions with or without heating, yield preparations corresponding to the definitions and modes of production specified above for the expressions “broth” and “consommé”; see, for example, especially (b).

In connection with the invention, the expression “fermented”, “ferment”, “fermentation”, “fermenting” and the like encompasses and/or means any microbial conversion of organic substances, including any microbial conversion especially under supply of oxygen. Fermentation or fermenting therefore especially refers to a microbial conversion of organic substances. Fermentation is used in a specific manner in the production, processing and/or enrichment of foodstuffs. This is done by addition of cultures of microorganisms such as especially bacteria, fungi or other biological cell cultures or else by the addition of enzymes (ferments) that carry out the fermentation as part of their enzyme-catalyzed metabolism. In some cases, the microorganisms are already naturally present on the starting materials, for instance in the case of a spontaneous fermentation. However, industrial fermentation with the aid of microorganisms generally involves adding microbial cultures in order to be able to better control the fermentation and to exclude undesired by-products.

In connection with the invention, the expression “microorganisms” encompasses and/or means, especially for foods and the production thereof, all acceptable microorganisms, i.e., microorganisms which are physiologically compatible and/or compatible in relation to health for humans. Therefore, infectious microorganisms and food-spoiling microorganisms are self-evidently excluded from the invention, since it is readily apparent that they are not among the acceptable microorganisms, i.e., microorganisms which are physiologically compatible and/or compatible in relation to health for humans.

In the context of the invention, preference is therefore given to microorganisms for food production, and, in particular, said microorganisms for food production are bacteria and/or fungi respectively for food production.

The invention relates to an above-described food, especially meat product, wherein the fermentation can be or is carried out by means of a microorganism, wherein the microorganism is a microorganism for food production, preferably wherein the microorganism for food production is selected from the group consisting of bacteria for food production and/or fungi for food production.

Preferably, the invention therefore also relates to an above-described food, especially meat product, wherein the fermentation can be or is carried out by means of a microorganism selected from the group consisting of Enterococcus sp., Kocuria sp., Micrococcus sp., Streptomyces sp., Tetragenococcus sp., Candida sp., Citeromyces sp., Cryptococcus sp. (noninfectious), Cystofilobasidium sp., Debaryomyces sp., Galactomyces sp., Geotrichum sp., Hanseniaspora sp., Hansenula sp., Hypopichia sp., Issatchenkia sp., Kluyveromyces sp., Metschnikowia sp., Pichia sp., Rhodosporidium sp., Rhodotorula sp., Saccharomyces sp., Sporobolomyces sp., Sterigmatomyces sp., Torulaspora sp., Trichosporon sp., Torulopsis sp., Yarrowia sp., Acremonium sp., Actinomucor sp., Amylomyces rouxii, Aspergillus sp., Aureobasidium pullulans (Pullularia pullulans), Cystofilobasidium infirmominiatum, Eurotium rubrum, Guehomyces pullulans, Monascus sp., Mucor sp., Neurospora intermedia, Neurospora sitophila, Penicillium sp., Rhizopus sp., Talaromyces sp., Thamnidium sp., Terfezia sp. and Tuber sp.

The bacteria for food production that are used according to the invention include, for example, those selected from the group consisting of Enterococcus sp., Kocuria sp., Micrococcus sp., Streptomyces sp. and Tetragenococcus sp.

The expression “Enterococcus sp.” covers, for example, Enterococcus faecium and Enterococcus faecalis, each independently of one another.

The expression “Kocuria sp.” covers, for example, Kocuria rhizophila, Kocuria salsicia, Kocuria kristinae and Kocuria varians, each independently of one another.

The expression “Micrococcus sp.” covers, for example, Micrococcus luteus and Micrococcus lylae, each independently of one another.

The expression “Streptomyces sp.” encompasses Streptomyces is a very species-rich genus of Actinobacteria. The species of this genus are Gram-positive, aerobic, mycelium-forming and multicellular, form spores, and have a high GC content. The GC content is a feature of DNA molecules. It indicates the percentage of the DNA bases guanine and cytosine based on all bases (guanine, cytosine, adenine and thymine).

The expression “Streptomyces sp.” covers, for example, Streptomyces griseus and Streptomyces mobaraensis, each independently of one another.

The expression “Tetragenococcus sp.” covers, for example, Tetragenococcus halophilus, Tetragenococcus muriaticus, Tetragenococcus koreensis, Tetragenococcus osmophilus and Tetragenococcus muriaticus, each independently of one another.

The fungi used according to the invention for food production include, for example, those selected from the group consisting of Candida sp., Citeromyces sp., Cryptococcus sp. (noninfectious), Cystofilobasidium sp., Debaryomyces sp., Galactomyces sp., Geotrichum sp., Hanseniaspora sp., Hansenula sp., Hypopichia sp., Issatchenkia sp., Kluyveromyces sp., Metschnikowia sp., Pichia sp., Rhodosporidium sp., Rhodotorula sp., Saccharomyces sp., Sporobolomyces sp., Sterigmatomyces sp., Torulaspora sp., Trichosporon sp., Torulopsis sp., Yarrowia sp., Acremonium sp., Actinomucor sp., Amylomyces rouxii, Aspergillus sp., Aureobasidium pullulans (Pullularia pullulans), Cystofilobasidium infirmominiatum, Eurotium rubrum, Guehomyces pullulans, Monascus sp., Mucor sp., Neurospora intermedia, Neurospora sitophila, Penicillium sp., Rhizopus sp., Talaromyces sp., Thamnidium elegans, Terfezia sp. and Tuber sp.

The expression “Candida sp.” covers, for example, Candida albicans, Candida blanckii, Candida brumptii, Candida catenulata, Candida colliculosa, Candida curvata, Candida diddensiae, Candida famata, Candida glabrata, Candida gropengiesseri, Candida guilliermondii, Candida haemulonii, Candida humicola, Candida iberica, Candida incommunis, Candida intermedia, Candida kefyr, Candida krusei, Candida lypolytica, Candida milleri, Candida mycoderma, Candida norvegica, Candida parapsilosis, Candida pelliculosa, Candida rugosa, Candida sake, Candida saitoana, Candida torulopsis, Candida tropicalis, Candida utilis, Candida valida, Candida versatilis, Candida vini and Candida zeylanoides, each independently of one another.

The expression “Citeromyces sp.” covers, for example, Citeromyces matritensis, each independently of one another.

The expression “Cryptococcus sp.” covers, for example, noninfectious Cryptococcus sp., especially Cryptococcus laurentii, Cryptococcus humicola, Cryptococcus albidus, Cryptococcus skinneri and Cryptococcus hungaricus, each independently of one another.

The expression “Cystofilobasidium sp.” covers, for example, Cystofilobasidium infirmominiatum, each independently of one another.

The expression “Debaryomyces sp.” covers, for example, Debaryomyces carsonii, Debaryomyces hansenii, Debaryomyces marama, Debaryomyces nicotianae, Debaryomyces occidentalis, Debaryomyces polymorphus, Debaryomyces subglobosus and Debaryomyces vanriji, each independently of one another.

The expression “Galactomyces sp.” covers, for example, Galactomyces geotrichum, each independently of one another.

The expression “Geotrichum sp.” covers, for example, Geotrichum candidum, each independently of one another.

The expression “Hanseniaspora sp.” covers, for example, Hanseniaspora uvarum, each independently of one another.

The expression “Hansenula sp.” covers, for example, Hansenula anomala, Hansenula citerii and Hansenula holstii, each independently of one another.

The expression “Hypopichia sp.” covers, for example, Hypopichia burtonii and Hypopichia pseudoburtonii, each independently of one another.

The expression “Issatchenkia sp.” covers, for example, Issatchenkia orientalis, each independently of one another.

The expression “Kluyveromyces sp.” covers, for example, Kluyveromyces lactis and Kluyveromyces marxianus, each independently of one another.

The expression “Metschnikowia sp.” covers, for example, Metschnikowia pulcherrima, each independently of one another.

The expression “Pichia sp.” covers, for example, Pichia anomala, Pichia burtonii, Pichia carsonii, Pichia ciferii, Pichia etchellsii, Pichia farinose, Pichia fermentans, Pichia guilliermondii, Pichia haplophila, Pichia holstii, Pichia membranifaciens, Pichia philogaea and Pichia sydowiorum, each independently of one another.

The expression “Rhodosporidium sp.” covers, for example, Rhodosporidium infirmominiatum, each independently of one another.

The expression “Rhodotorula sp.” covers, for example, Rhodotorula glutinis, Rhodotorula rubra, Rhodotorula minuta and Rhodotorula mucilaginosa, each independently of one another.

The expression “Saccharomyces sp.” covers, for example, Saccharomyces cerevisiae, Saccharomyces bayanus, Saccharomyces carlsbergensis, Saccharomyces exiguous, Saccharomyces pastorianus, Saccharomyces rosei and Saccharomyces uvarum, each independently of one another.

The expression “Sporobolomyces sp.” covers, for example, Sporobolomyces roseus, each independently.

The expression “Sterigmatomyces sp.” covers, for example, Sterigmatomyces halophilus, each independently of one another.

The expression “Torulaspora sp.” covers, for example, Torulaspora delbrueckii, each independently of one another.

The expression “Trichosporon sp.” covers, for example, Trichosporon pullulans, Trichosporon mucoides, Trichosporon beigelii, Trichosporon terrestre, Trichosporon ovoides, Trichosporon cutaneum and Trichosporon moniliforme, each independently of one another.

The expression “Torulopsis sp.” covers, for example, Torulopsis apicola, Torulopsis candida, Torulopsis etchellsii, Torulopsis famata, Torulopsis pulcherrima and Torulopsis sphaerica, each independently of one another.

The expression “Yarrowia sp.” covers, for example, Yarrowia lipolytica, Yarrowia porcine, each independently of one another.

The expression “Acremonium sp.” covers, for example, each independently of one another.

The expression “Actinomucor sp.” covers, for example, Actinomucor elegans, each independently of one another.

The expression “Amylomyces sp.” covers, for example, Amylomyces rouxii, each independently of one another.

The expression “Aspergillus sp.” covers, for example, Aspergillus oryzae, Aspergillus candidus, Aspergillus niger, Aspergillus acidus, Aspergillus flavus, Aspergillus glaucus, Aspergillus sojae, Aspergillus ochraceus, Aspergillus fumigatus and Aspergillus acidus, each independently of one another.

The expression “Aureobasidium or Pullularia” covers, for example, Aureobasidium pullulans (Pullularia pullulans), each independently of one another.

The expression “Eurotium” covers, for example, Eurotium rubrum, each independently of one another.

The expression “Guehomyces” covers, for example, Guehomyces pullulans, each independently of one another.

The expression “Monascus sp.” covers, for example, Monascus purpureus, Monascus ruber, Monascus pilosius, each independently of one another.

The expression “Mucor sp.” covers, for example, Mucor racemosus, Mucor hiemalis, Mucor indicus, Mucor disperses, Mucor mucedo, Mucor silvaticus, Mucor subtilissimus and Mucor plumbeus, each independently of one another.

The expression “Neurospora” covers, for example, Neurospora intermedia, Neurospora sitophila, each independently of one another.

The expression “Penicillium sp.” covers, for example, Penicillium aurantiogriseum, Penicillium brevicompactum, Penicillium camemberti, Penicillium caseifulvum, Penicillium chysogenum, Penicillium commune, Penicillium gladioli, Penicillium griseovulvum, Penicillium implicatum, Penicillium nalgiovense, Penicillium olsonii, Penicillium roqueforti, Penicillium solitum, Penicillium verrucosum and Penicillium waksmanii, each independently of one another.

The expression “Rhizopus sp.” covers, for example, Rhizopus oligosporus, Rhizopus microsporus, Rhizopus chinensis, Rhizopus oryzae, Rhizopus arrhizus and Rhizopus stolonifer, each independently of one another.

The expression “Talaromyces sp.” covers, for example, Talaromyces wortmannii, each independently of one another.

The expression “Thamnidium” covers, for example, Thamnidium elegans, each independently of one another.

The expression “Terfezia sp.” covers, for example, Terfezia alsheikhii, Terfezia arenaria, Terfezia boudieri, Terfezia canariensis, Terfezia claveryi, Terfezia leptoderma, Terfezia olbiensis, each independently of one another.

The expression “Tuber sp.” covers, for example, Tuber blotii, Tuber magnatum, Tuber oligospermum and Tuber melanosporum, each independently of one another.

Preferably, the food according to the invention can relate to a meat product.

In a preferred embodiment of the invention, the food according to the invention is therefore a meat product. Such meat products according to the invention are especially selected from the group consisting of meat preparation, uncooked sausage, scalded sausage, cooked sausage, cooked cured article, uncooked cure article, aspic and jellied meat, as respectively defined above.

Further preference according to the invention is therefore given to an above-described food, wherein the food is a meat product comprising dry matter of fermented meat, based on the dry matter of the entire meat product, of
0.01% by weight to 15.00% by weight, if the meat product is a finely minced product, or
15.01% by weight to 80.00% by weight, if the meat product is a finely minced product containing coarse inset and the inset substantially consists of fermented meat, or
80.01% by weight to 99.9% by weight, if the meat product is a cooked cured-meat product.
In connection with the invention, the expression “dry matter” encompasses and/or means that constituent of a food according to the invention, especially a meat product, that remains after removal of the water matter present (of the water content). The dry matter or dry substance is therefore that constituent of a sample that remains after removal of the water matter present (of the water content). In food analysis, the dry matter of a food, especially a foodstuff, is generally gravimetrically by drying a sample in a drying cabinet at just over 100° C., for example at approx. 105° C. Dry matter is significant because all other specified contents are usually based thereon. A commonly used method for measuring the water content of samples is the gravimetric method (also called the oven-drying/weighing drying method). In this case, the water content of the sample is determined by the weight loss upon drying. After collection, the sample is packed in an air-tight manner and weighed. Thereafter, the sample is dried in a drying oven at approx. 105° C. until there is a consistency in weight in successive weighings. After drying, the sample is weighed again. From the difference in the weighings, it is possible to ascertain the water content of the sample and thus also the dry matter or dry substance.

The expressions “finely minced” or “or very finely minced”, as used in connection with the invention, refer to a degree of mincing of a sample, for example a given product, raw material, food, meat product and the like, and of a constituent and/or additive and the like, wherein the degree of mincing among experts is usually specified as particle size, range of a particle size and/or particle-size distribution. Here, in the context of the present invention, the arithmetical mean value is to be assumed when a particle size is specified, unless otherwise indicated.

In connection with the invention, the expression “finely minced” encompasses and/or means finely minced products and/or finely minced constituents thereof having particle sizes of 0.5 mm to 3 mm as arithmetical mean value.

Finely minced meat products are therefore to be understood to mean those meat products that were subjected to a mincing process through the use of meat grinders, bowl cutters and/or other machines known to a person skilled in the art and suitable for fine mincing of products. In this case, the cell structure is only negligibly destroyed by action of shearing and grinding forces, and the overwhelming proportion of the cell structure remains intact. What are usually achieved here are particle sizes of 0.5 mm to 3 mm of finely minced products.

In connection with the invention, the expression “very finely minced” encompasses and/or means very finely minced products and/or very finely minced constituents thereof having particle sizes of <0.5 mm as arithmetical mean value.

Very finely minced meat products are therefore to be understood to mean those meat products, the cell structure of which is very largely broken up by action of shearing and grinding forces. Very fine mincing of meat products generally takes place in bowl cutters, emulsifiers, colloid mills and/or other machines known to a person skilled in the art and suitable for very fine mincing of products. Here, the particle size achieved is <0.5 mm.

To determine particle sizes of finely minced and/or very finely minced products, a person skilled in the art can rely on the methods known in the prior art for determining particle sizes and the distribution thereof (particle-size distribution). For a very finely minced sample, it is possible to use particle-size analysis by laser diffraction as the method for measuring particle size. To this end, the product is first dispersed in water and then added to the measurement system. For larger particles, for example of a finely minced sample, what is recommended is a microscopic size determination and/or optionally also a particle-size determination by an image-processing method.

Products used in connection with the expression “finely minced” or “very finely minced” in the invention are therefore different and distinguishable from larger types of mincing, for example mere “coarsely minced” constituents such as, for example, a “coarsely minced inset” or “coarse inset”. Coarsely minced meat products are understood to mean those meat products that were minced to a piece size of >3 mm through the use of hand knives, meat grinders, cube-cutting machines, bowl cutters and/or other machines known to a person skilled in the art and suitable for coarse mincing of products.

Coarsely minced meat can, inter alia, also be used as inset in finely minced and/or very finely minced meat products.

Preference is given to a food according to the invention that is a meat product, and that originates from 3, preferably 2, preferably one animal species and the fermented meat originates from another species.

In a further embodiment of the food according to the invention that is a meat product, the invention relates to an above-defined meat product, wherein the meat used originates from at least one animal species selected from the group consisting of pig, cattle, turkey, chicken, sheep, especially lamb, ostrich, caribou, moose, deer, rabbit and hare.

The invention further provides for the use of (i) at least partially fermented meat, or (ii) an extract of at least partially fermented meat, as taste-active substance in a food, wherein (i) the at least partially fermented meat, or (ii) the extract of the at least partially fermented meat, is added to the food and is preferably distributed across the entire cross-section of the food and the food is preferably a meat product and is further preferably selected from the group consisting of meat preparation, uncooked sausage, scalded sausage, cooked sausage, cooked cured article, uncooked cured article, aspic and jellied meat.

The invention further relates to a method for producing a food, comprising the steps of:

a) providing a food, especially a meat product, or the ingredients of a food, especially of a meat product, especially selected from the group consisting of meat preparation, uncooked sausage, scalded sausage, cooked sausage, cooked cured article, uncooked cured article, aspic and jellied meat.

b) producing and/or providing (i) at least partially fermented fermented meat, or (ii) an extract, a solution or a suspension of at least partially fermented meat, wherein the meat is or was fermented under at least partially aerobic conditions, and under conditions at which the relative air humidity of the ambient atmosphere is below the associated a_{w} value for the meat to be fermented, and the fermentation takes or took place under addition of a starter culture, preferably a microorganism as defined in claim 2.

c) if the ingredients of a food were provided in step a), producing the food and

d)i) admixing the food with (i) the at least partially fermented fermented meat, or (ii) the extract, the solution or the suspension of at least partially fermented meat, or d)ii) if the ingredients of a food were provided in step a), mixing (i) the at least partially fermented meat, or (ii) the extract, the solution or the suspension of at least partially fermented meat, with the ingredients of the food before step c),

with the result that a food as defined above is preferably formed.

Through the relative air humidity of the ambient atmosphere that must be present according to the invention during the fermentation, it is possible for a person skilled in the art to distinguish and differentiate the fermentation according to the invention from random fermentations and the result thereof.

In connection with the invention, the expression “a_{w} value” refers to the activity of water of a food and is a measure of the “available” or “active” water in contrast to the mere specification of the water content.

Activity of water (a_{w} value) is defined as the ratio of the partial pressure of water vapor in the food (P) to the saturation vapor pressure of pure water (P₀) at a certain temperature. Here, activity of water is synonymous with the (relative) equilibrium humidity, i.e., the relative air humidity at which the food (again at the given temperature) is in equilibrium with the ambient air, i.e., neither loses nor takes up water. Relative air humidity is usually specified in the auxiliary unit of measurement percent (%), and relative equilibrium humidity (“REH”) is therefore calculated as REH=a_{w}*100. In the context of this text, the a_{w} value assigned to a certain relative air humidity (in %) according to the above formula is the a_{w} value assigned to this air humidity. For the method according to the invention, the a_{w} value of the raw material is as >REH[%]/100.

In the simplest case, activity of water (a_{w} value) is measured by introducing a sample of the food into a hermetically sealed container and measuring the air humidity which ensues in the container using a hygrometer.

Activity of water (a_{w} value) is significant because it is not only purely water content that is important for the shelf life of foods, but also the extent to which the water is bound by a substrate. Activity of water influences the growth of microorganisms, the course of chemical processes such as fat oxidation and nonenzymatic browning, the activity of enzymes, and the physical properties of the food.

Activity of water or the a_{w} value is therefore an important measure with regard to the shelf life of foods and influences the occurrence of microorganisms, including of decay pathogens, which have different demands for freely available water. If there is a lack of free water, the growth processes of some water-loving microorganisms are slowed, and sensitive organisms can even be killed; xerophilic organisms by contrast grow better at falling water content. For most microorganisms, the growth optimum is an a_{w} value of 0.98 to 1. However, there are microorganisms which tolerate a distinctly lower activity of water of up to 0.6 (so-called xerophiles).

In a preferred method according to the invention, the invention relates to a method as defined above, wherein minced fermented meat is used in the respective step d).

It is preferred according to the invention that the fermented meat to be used according to the invention is produced under one or more or, particularly preferably, all of the following conditions:
temperature +10° C. to +40° C.
relative air humidity: 60% to 100%
air velocity for aeration: 0 m/sec to 25 m/sec
action time of the microorganisms 24 h to 12 weeks.

In a further preferred method according to the invention, the invention relates to a method as defined above, wherein an aqueous, ethanolic or oily extract or an aqueous suspension of fermented meat is used in the respective step d).

In process engineering and in the present invention, the expression “extract” encompasses and/or means the extraction of constituents, substances or mixtures of substances from a natural raw material, especially a raw material of animal origin, using an extractant, for example water or water-containing extractant, ethanol or ethanol-containing extractant and/or oil or oil-containing extractant, wherein the constituents, substances or mixtures of substances that are extracted from the raw material are present in dissolved form and/or finely divided form and/or very finely divided form in the extract obtained by extraction. Providing an extract can be accomplished by a person skilled in the art by means of the methods known per se in the prior art. The expression “aqueous extract” thus means an extract generated using water or water-containing extractant, the expression “ethanolic extract” thus means an extract generated using ethanol or ethanol-containing extractant, and the expression “oily extract” thus means an extract generated using oil or oil-containing extractant.

In the context of this text, an aqueous suspension of fermented meat is to be understood to mean that the fermented meat to be used according to the invention has been minced such that it was possible to suspend it in an aqueous solution.

Preferably, the invention relates to a method as defined above, wherein the extract of the at least partially fermented meat is injected in step d)i).

Alternative forms of admixing as per step d)i) are setting in a suspension, a solution or an extract of the fermented meat to be used according to the invention, preferably under movement, especially under tumbling.

In connection with the invention, the expression “injected”, “inject”, “injection” and the like encompasses and/or means “injected (into)”, “inject (into)”, “injection (into)”.

The invention shall be more particularly elucidated below on the basis of representative examples.

### EXAMPLES

### Example 1

### Production of Fermented Meat (Lachschinken Containing Edible Mold):

The basis of the production of Lachsschinken is the provision of raw articles, such as back-muscle meat, spices, auxiliaries and process materials as per the product specifications and ingredients list.

First, the curing brine for the production process is mixed on the basis of the ingredients list. Thereafter, the product is wet-cured for four hours under addition of the brine in the curing container. At 10-minute intervals, the back-muscle meats are automatically restacked in the container by a plunger. After the curing process is completed, the back-muscle meats are taken out of the brine and neatly stacked into a tub. The back-muscle meats reside in the tub for approx. 1-1.5 weeks for after-curing. After-curing involves an equalization of the salt concentration from the edge zones to the core and it additionally serves for intensification of flavor. Moreover, excess brine can already be given off.

Following after-curing, the back-muscle meats are removed from the tubs and restacked into latticed racks intended therefor. In the following maturation and drying process, the racks pass through different climatic conditions in climatic chambers. The respective conditions and residence times in the chambers are typical of maturation of uncooked cured articles. After approx. 7-8 hours in the climatic chambers, the back-muscle meats are subjected to generous singular spraying (provision of mold as per the ingredients list) with the edible mold culture (maturation cultures) “Geotrichum candidum” and “Penicillium nalgiovensis”. The mold cultures are mixed beforehand in a container according to the ingredients list. Spraying is carried out by using an atomizer which generates a fine mist which lies around the product. The mold cultures can develop in the further maturation process in the climatic chambers and form a white surface coating.

| | | | | | | | | Smoke | |
|---|---|---|---|---|---|---|---|---|---|
| | | | | | Air | | | addition/ | Core |
| | | | Time | Temperature | humidity | Surrounding | Fresh air | other | temperature |
| Day | Step | Process | [h] | [° C.] | [%] | air [%] | [min. 20%] | remark | [target: ° C.] |
| 1st | 1 | C | approx. | 48 | 50 | 100 | | | Until 36° C. |
| | | | 4 | | | | | | is reached |
| | | | | | | | | | in the core |
| 1st | 2 | C | 24 | 24 | 96 | 25 | | Spraying | |
| | | | | | | | | with edible | |
| | | | | | | | | mold | |
| 2nd | 2 | C | 24 | 24 | 96 | 25 | | | |
| 3rd | 3 | C | 24 | 24 | 88 | 35 | | | |
| 4th | 4 | C | 24 | 22 | 82 | 35 | | | |
| 5th | 5 | C | 24 | 20 | 78 | 60 | | | |
| 6th | 6 | C | 99 | 18 | 75 | 60 | | | |

C = climate (no automatic fresh air/surrounding air)

After the end of the maturation process, the back-muscle meats are placed into cold storage from the climatic chambers for further drying for 1-1.5 weeks. After the maturation process in the climatic chambers, the drying loss is 28-29% (starting weight: weight after after-curing). Once the total drying loss is 31% (starting weight: weight after after-curing), the product is finished as per specification and is made available to the packaging department.

### Example 2

Production of a Scalded Sausage/Lyoner with Addition of Fermented Meat

### Meat Recipe:

| | | |
|---|---|---|
| | | Quantity |
| Raw material | Classification *) | (%) |

| | | | |
|---|---|---|---|
| Pork | SII | (LS 1.122) | 35 |
| Pork belly | SV | (LS 1.123) | 20 |
| Pork jowls | SVI | (LS 1.123) | 10 |
| Fatback | SVIII | (LS 1.212) | 15 |
| Fill material/ice | | | 20 |
| Total | | | 100 |

*) Classification according to the Leitsätze für Fleisch und Fleischerzeugnisse (Guidelines for meat and meat products)

### Addition Agents:

| | Quantity |
|---|---|
| Addition agents (ingredient or additives) | (%) |
| Nitrite curing salt (0.5% NO2) (NCS) | 1.60 |
| Sodium diphosphate (E 450) | 0.30 |
| Sodium ascorbate (E 301) | 0.05 |
| Fermented meat, minced (from Example 1.) | 2.50 |

NCS = nitrite curing salt

### Production:

Scalded sausage according to the total sausage-meat method (final temperature of cutter 12° C.).

Mince the prefermented meat in a meat cutter at 5000 blade revolutions per min for 5 minutes (bowl speed: 16 revolutions per min)

Grind the well-cooled meat and fatty material together through a 3 mm perforated disk and add them to a meat cutter.

This is followed by adding the nitrite curing salt and the phosphate and ascorbate. Thereafter, cutting is carried out for about 5 rounds at a slow blade speed (1000 rpm). Sausage-meat temperature approx. 5° C.

The fill material is then added, the sausage-meat temperature thereby dropping to approx. 0° C.

Thereafter, the sausage meat is cut until it has reached a sausage-meat temperature of approx. 4° C. The preminced and fermented meat from Example 1 is now added.

The sausage meat is then cut to completion under vacuum to a sausage-meat temperature of approx. 12° C.

Filling into polyamide casings, diameter 90 mm.

Cooking program:
1 hour at 50° C. chamber temperature
78° C. chamber temperature to 71° C. core temperature
showering at approx. 10° C. water temperature and subsequent cooling in a cold store at approx. 4° C.

### Example 3

Production of Cooked Cured Articles (Reconstituted Ham) with Addition of 3% Fermented Meat

### Meat Material:

100 kg of pork SI (guideline 1.121), pork top round and pork bottom round.

### Brine Composition Calculated for 13% Infusion

| | Quantity | Quantity |
|---|---|---|
| | (% in the | (kg of brine |
| | product) | additive) |
| Water | | 5.000 |
| Ice | | 2.236 |
| Nitrite curing salt (0.5% NaNO2) | 1.60 | 1.808 |
| Sodium diphosphate (E 450) and | 0.15 | 0.170 |
| sodium triphosphate (E 451) | | |
| Sodium ascorbate (E 301) | 0.05 | 5.5 |
| Dextrose | 0.30 | 0.390 |
| Total | | 13.000 |

### Mincing and Production of the Infusion Brine:

The fermented meat from Example 1 is preminced in a meat cutter at 5000 blade revolutions per min for 5 minutes.

This is followed by brine production using a rotor-stator disperser from Kotthoff. Here, the cold water is initially charged, followed by the addition of the diphosphate/triphosphate, the ascorbate and the dextrose. After these components are completely dissolved, the NCS is then added. After the NCS is dissolved, the prior minced fermented meat is added. After these components are uniformly distributed, the ice is added. The brine is then dispersed until the ice is completely dissolved (brine temperature approx. 2° C.).

Thereafter, the brine produced is then moved across a colloid mill in order to achieve very fine mincing.

### Production of the Reconstituted Ham:

The pork top round and pork bottom round are thoroughly removed of fat and sinews.

Thereafter, they are ground with the aid of a meat grinder to approx. 20-30 mm in size.

The ground meat is then added together with the appropriate quantity of the previously produced infusion brine to a tumbler (from Vakona, one-armed stirring tumbler, model ESK 125 STL).

The tumbling times are 5 hours in continuous operation at 10 rounds per minute and 1° C. tumbling temperature.

After tumbling, the mass is filled into polyamide casings and placed into a cooking apparatus.

Cooking program: Cooked for 1 hour at 50° C. chamber temperature and then heated at 78° C. chamber temperature up to 71° C. core temperature.

The cooking process is followed by a 10-minute cooling of the reconstituted ham under cold water. Further cooling is carried out in a cold store at approx. 4° C.

### Example 4

### Sensory Assessment of Test Specimens by an Expert Panel

Test specimens were produced as described below and subjected to a sensory assessment by an expert panel:
I.) Production of cooked cured articles (reconstituted ham) with addition of 3% and 1.5% prefermented meat
II.) Production of a scalded sausage/Lyoner containing mold-covered Lachsschinken portions, from Kemper
III.) Addition of mold-covered Lachsschinken (fermented meat, whole back-muscle meats) on top on the basis of a meat recipe

“NCS” means nitrite curing salt hereinbelow.

### Task:

It is important here that the taste profiles are described as accurately as possible without making a ranking according to popularity. The goal here is to make it clear that the method can achieve taste profiles in cooked meat products that would not be possible without use of the method. For the sensory analysis, 4 different products were produced in each case for reconstituted ham and scalded sausage at the DIL (German institute for food technology). The tests and recipes are listed below. The sample designation is yellow, red, blue and green and is assigned to the recipes.

### Example 4.1

I.) Production of Cooked Cured Articles (Reconstituted Ham) with Addition of 3% and 1.5% Fermented Meat

### Meat Material:

10 kg of pork SI (guideline 1.121), pork top round (meat provided by Kemper).

Test 1: Brine composition calculated for 10% Infusion, “yellow”

| | Quantity | Quantity |
|---|---|---|
| | (% in the | (kg of brine |
| | product) | additive) |
| Water | | 580.00 |
| Ice | | 200.00 |
| Nitrite curing salt (0.5% NaNO2) | 1.80 | 198.00 |
| Sodium diphosphate (E 450) | 0.15 | 16.50 |
| Sodium ascorbate (E 301) | 0.05 | 5.5 |
| Total | | 1000.00 |

Test 2: Brine composition calculated for 10%
infusion - Kemper test, “red”

| | Quantity | Quantity |
|---|---|---|
| | (% in the | (kg of brine |
| | product) | additive) |
| Water | | 500.00 |
| Ice | | 175.50 |
| Nitrite curing salt (0.5% NaNO2) | 1.85 | 203.50 |
| TKPP, liquid (E 450) - Kemper sample | 0.38 | 41.80 |
| Sodium ascorbate (E 301) | 0.04 | 4.4 |
| Dextrose | 0.68 | 74.80 |
| Total | | 1000.00 |

Test 3: Brine composition calculated for 10%
infusion + 1.5% fermented meat, “blue”

| | Quantity | Quantity |
|---|---|---|
| | (% in the | (kg of brine |
| | product) | additive) |
| Water | | 580.00 |
| Ice | | 200.00 |
| Nitrite curing salt (0.5% NaNO₂) | 1.60 | 198.00 |
| Sodium diphosphate (E 450) | 0.15 | 16.50 |
| Sodium ascorbate (E 301) | 0.05 | 5.5 |
| Fermented meat (minced, see below) | 1.50 | 165.00 |
| Total | | 1165.00 |

Test 4: Brine composition calculated for 10%
infusion + 3.0% fermented meat, “green”

| | Quantity | Quantity |
|---|---|---|
| | (% in the | (kg of brine |
| | product) | additive) |
| Water | | 580.00 |
| Ice | | 200.00 |
| Nitrite curing salt (0.5% NaNO₂) | 1.60 | 198.00 |
| Sodium diphosphate (E 450) | 0.15 | 16.50 |
| Sodium ascorbate (E 301) | 0.05 | 5.5 |
| Fermented meat (minced, see below) | 3.00 | 330.00 |
| Total | | 1330.00 |

### Mincing and Production of the Infusion Brine:

The fermented meat is preminced in a meat cutter at 5000 blade revolutions per min for 5 minutes.

This is followed by brine production using a rotor-stator disperser from Kotthoff. Here, the cold water is initially charged, followed by the addition of the diphosphate/triphosphate, the ascorbate and the dextrose. After these components are completely dissolved, the NCS is then added. After the NCS is dissolved, the prior minced prefermented meat is added. After these components are uniformly distributed, the ice is added. The brine is then dispersed until the ice is completely dissolved (brine temperature approx. 2° C.).

Thereafter, the brine produced is then moved across a colloid mill in order to achieve very fine mincing.

### Example 4.2

II.) Production of a Scalded Sausage/Lyoner Containing Fermented Meat (Mold-Covered Lachsschinken) Portions, from Kemper

### Inset Material:

Mold-covered Lachsschinken (whole pieces) were provided by Kemper

### Meat Recipe:

| | | Quantity | Quantity |
|---|---|---|---|
| Raw material | Classification *⁾ | (%) | (kg) |
| Pork | SII-SIII | 35 | 3.5 |
| Pork belly | SV | 20 | 2 |
| Pork jowls | SVI | 10 | 1 |
| Fatback | SVIII | 15 | 1.5 |
| Fill material/ice | | 20 | 2 |
| Total | | 100 | 10 |

*⁾ Classification according to the Leitsätze für Fleisch und Fleischerzeugnisse (Guidelines for meat and meat products)

### Addition Agents:

| | | Quantity | Quantity |
|---|---|---|---|
| Product | Test | (%) | (g/10 kg) |
| NCS (0.5% NO2) | 1 | 1.80 | 180 |
| | 2 | 1.80 | 180 |
| | 3 | 1.67 | 167 |
| | 4 | 1.75 | 175 |
| Sodium diphosphate | | 0.30 | 30 |
| T1, T3, T4 Ascorbate | | 0.05 | 5 |
| T2 Lyoner spice from Kemper | | 0.71 | 71 |
| including ascorbate | | | |

### Example 4.3

### III) Addition of Mold-Covered Lachsschinken Containing Fermented Meat (Whole Back-Muscle Meats) on Top on the Basis of a Meat Recipe:

| | | | Quantity on |
|---|---|---|---|
| | | Quantity | top to 10 kg |
| | | (%) | (kg) |
| 1 “yellow” | Without additive | — | — |
| 2 “red” | Without additive | — | — |
| 3 “blue” | Mold-covered Lachsschinken | 2.5 | 0.25 |
| 4 “green” | Mold-covered Lachsschinken | 1 | 0.10 |

### Production:

Mold-covered Lachsschinken portions were minced in a ratio of 50:50 (end cuts and cold cuts) in a cutter at 5000 blade revolutions per min for 3 minutes.

Production of the scalded sausage according to the all-in method (final temperature of cutter 12° C.)

Addition of the precut Lachsschinken portions at a sausage-meat temperature of approx. 4° C.

Filling into sterile castings, diameter 90 mm (plunger filler).

### Cooking Program:

1 hour at 50° C. chamber temperature
78° C. chamber temperature to 71° C. core temperature

### Example 4.4

### IV.) Description of the Method for the Taste and Consistency Profiles

### Example 4.4.1. Cooked Ham

The present quality test is a sensory assessment (sensory test) for scalded and cooked articles, especially cooked ham. The samples are tested neutrally by a group of testers (panel), i.e., without knowledge of the production conditions, seasoning, etc. A panel leader directs the proper and appropriate testing within the panel group. The established product properties and the results from the testers are to be respectively documented in test documents. This test was explicitly developed for the cooked ham product group. The product was assessed according to taste and consistency properties specified beforehand (Annex 1). The group result of the defined test represents an individual taste and consistency profile for the product examined.

### Method: Simple Descriptive Test

A panel performs a sensory assessment and provides a simple description of the product. The individual results from all test participants are pooled to give a group result (feature profile). The goal of the descriptive test is the neutral description of sensory product properties and product impressions. The test method is based on the “Simple Descriptive Test”, which is defined as DIN standard 10964 and is contained under paragraph 64 in the LFGB (L 00.90-6).

### Goal

The products are described by individual attributes. The goal of the test is to describe an exact sensory profile of the products. In particular, the testers describe a profile using qualitative properties defining the value of the product. The feature profiles are divided into appearance/color, odor, taste and texture, defined according to sensory perception.

### Use

This method is used inter alia in profile description, in product development and optimization, and when comparing multiple products.

### Procedure

To create a qualitative feature profile (e.g., appearance/color, odor, taste or texture), it is first necessary to collect descriptive terms. Thereafter, the lists of terms must be structured, this involving combining similar terms and eliminating hedonic attributes (popularity terms). The final number of property descriptions should not exceed a maximum of 12 terms per test feature. After the number of terms has been appropriately reduced, what follows in the second step in the context of individual testing is the description of the products on the basis of the feature properties developed (lists of terms). The test persons employed here must have a comprehensive basic sensory knowledge and be capable of appropriately describing the product properties registered.

The minimum number of testers is generally guided by the goal of the test plan; however, it is generally six persons in order to obtain an interpretable result. The specimens were tested at the DIL (German institute for food technology) by a trained panel consisting of 12 persons. The sensory tests concerned taste and consistency only.

### Example 4.4.2. Scalded Sausage

The present quality test is a sensory assessment (sensory test) for scalded sausage that is scalded and cooked. The test is carried out analogously as described under 4.4.1. The samples are tested neutrally by a group of testers (panel), i.e., without knowledge of the production conditions, seasoning, etc. A panel leader directs the proper and appropriate testing within the panel group. The established product properties and the results from the testers are to be respectively documented in test documents.

### Example 4.5. Sensory Analysis Results

### Example 4.5.1. Cooked Ham

### Taste and Consistency Profiles:

### Sample “Yellow”

In the test, the panel perceived a mild salty and sour taste. The cooked ham had very slight seasoning. The inherent meat taste was distinctly perceived. There was no foreign taste present. Furthermore, the sample had a characteristic firmness with a slightly dry consistency. In conclusion, the panel perceived unpronounced seasoning with expression of typical consistency.

### Sample “Red”

In the test, the panel perceived a mild salty and sour taste. The cooked ham had slight seasoning. A fresh inherent meat taste was distinctly perceived. There was no foreign taste present. Furthermore, the sample had a characteristic firmness with a slightly dry consistency. In conclusion, the panel perceived slightly pronounced seasoning with expression of typical consistency.

### Sample “Blue”

In the test, the panel perceived a mild salty and sour taste. The cooked ham had slight to well-balanced seasoning. An inherent meat taste was perceived. Signs of a foreign taste were present, but it could not be defined. Furthermore, the sample had a characteristic firmness with a slightly dry consistency. In conclusion, the panel perceived slight to well-balanced seasoning with expression of typical consistency. Furthermore, an atypical taste which could not be exactly described was perceived in the cooked ham sample. Moreover, the sample had nutty, yeasty and cheesy taste notes.

### Sample “Green”

In the test, the panel perceived a mild salty and sour taste. The cooked ham had strong intense seasoning. An inherent meat taste was distinctly perceived. Signs of a foreign taste were present, but it could not be defined. Furthermore, the sample had a soft meat structure with a slightly watery consistency. In conclusion, the panel perceived strong intense seasoning with expression of soft consistency. Furthermore, an atypical taste which could not be exactly described was perceived in the cooked ham sample. Moreover, the sample had slight nutty, yeasty and cheesy taste notes.

### Table 1A and 1B: For the Sensory Analysis Profiles

A. Taste profile

| Feature properties | Expression |
|---|---|
| Salty | Mild or strong |
| Sour | Mild or strong |
| Seasoning | Seasoning weak to strong, or |
| | just right (well-balanced) |
| Meat flavor | Present, yes or no |
| Fresh | Present, yes or no |
| Old taste | Present, yes or no |
| Bitter | Present, yes or no |
| Metallic | Present, yes or no |

B. Consistency profile

| Feature properties | Expression |
|---|---|
| Firmness (biting behavior) | Soft or firm |
| Chewing behavior in oral cavity | Characteristic or too dry |
| Chewing behavior in oral cavity | Characteristic or tough |

### Example 4.5.2. Scalded Sausage

### Taste and Consistency Profile

### Sample “Yellow”

In the test, the panel perceived a mild salty taste. The scalded sausage had very slight seasoning. The inherent meat taste was very slightly pronounced. Furthermore, there was no foreign taste present. Furthermore, the sample had a characteristic firmness with a characteristic consistency. In conclusion, the panel perceived bland and unpronounced seasoning (low-taste) with expression of typical consistency.

### Sample “Red”

In the test, the panel perceived a salty taste. The scalded sausage had strong seasoning. The inherent meat taste was very slightly pronounced. Furthermore, there was a foreign taste present. Furthermore, the sample had a characteristic firmness with a characteristic consistency. In conclusion, the panel perceived intense and highly pronounced seasoning with expression of typical consistency. The perceived foreign taste might have been caused by the seasoning.

### Sample “Blue”

In the test, the panel perceived a salty taste. The scalded sausage had strong intense seasoning. An inherent meat taste was perceived. There was a tendency for some testers to perceive nutty and yeasty taste notes and also a distinctly cheesy note. A foreign taste was present, but it could not be defined. It was described as atypical for a scalded sausage. Furthermore, the sample had a soft meat structure with a slightly watery consistency. In conclusion, the panel perceived strong intense seasoning with expression of soft consistency. Furthermore, an atypical taste which could not be exactly described was perceived in the scalded sausage sample. Moreover, the sample had nutty, yeasty and cheesy taste notes.

### Sample “Green”

In the test, the panel perceived a mild salty taste. The scalded sausage had weak to well-balanced seasoning. An inherent meat taste was perceived. There was a tendency for some testers to perceive slight nutty, yeasty and cheesy taste notes. A slight foreign taste was present, but it could not be defined. Furthermore, the sample had a firm meat structure with a slightly watery consistency. In conclusion, the panel perceived weak to well-balanced seasoning with expression of characteristic consistency. Furthermore, an atypical taste which could not be exactly described was perceived in the scalded sausage sample. Moreover, the sample had slight nutty, yeasty and cheesy taste notes.

We claim:

1. A food, comprising (i) at least partially fermented meat, or (ii) an extract of at least partially fermented meat, as taste-active substance in the food, wherein (i) the at least partially fermented meat or (ii) the extract of the at least partially meat of animal origin can have reached the other constituents of the food only by addition to the food, wherein the at least partial fermentation is carried out under at least partially aerobic conditions.

2. The food as claimed in claim 1, wherein the fermentation can be or is carried out by means of a microorganism selected from the group consisting of Enterococcus sp., Kocuria sp., Micrococcus sp., Streptomyces sp., Tetragenococcus sp., Candida sp., Citeromyces sp., Cryptococcus sp. (noninfectious), Cystofilobasidium sp., Debaryomyces sp., Galactomyces sp., Geotrichum sp., Hanseniaspora sp., Hansenula sp., Hypopichia sp., Issatchenkia sp., Kluyveromyces sp., Metschnikowia sp., Pichia sp., Rhodosporidium sp., Rhodotorula sp., Saccharomyces sp., Sporobolomyces sp., Sterigmatomyces sp., Torulaspora sp., Trichosporon sp., Torulopsis sp., Yarrowia sp., Acremonium sp., Actinomucor sp., Amylomyces rouxii, Aspergillus sp., Aureobasidium pullulans (Pullularia pullulans), Cystofilobasidium infirmominiatum, Eurotium rubrum, Guehomyces pullulans, Monascus sp., Mucor sp., Neurospora intermedia, Neurospora sitophila, Penicillium sp., Rhizopus sp., Talaromyces sp., Thamnidium sp., Terfezia sp. and Tuber sp.

3. The food as claimed in claim 1, wherein the food is a meat product comprising dry matter of fermented meat, based on the dry matter of the entire meat product, of
0.01% by weight to 15.00% by weight, if the meat product is a finely minced product, or
15.01% by weight to 80.00% by weight, if the meat product is a finely minced product containing coarse inset and the inset substantially consists of fermented meat, or
80.01% by weight to 99.9% by weight, if the meat product is a cooked cured-meat product.

4. The meat product as claimed in claim 3, wherein the nonfermented meat is ≥50% by weight of the meat, based on the total proportion of meat in the meat product, and originates from at least one animal species and the fermented meat originates from another species.

5. The meat product as claimed in claim 3, wherein the meat used originates from at least one species selected from the group consisting of pig, cattle, turkey, chicken, sheep, especially lamb, ostrich, caribou, moose, deer, rabbit and hare.

6. (canceled)

7. A method for producing a food, comprising the steps of:
a) providing a food, especially a meat product, or the ingredients of a food, especially of a meat product, especially selected from the group consisting of meat preparation, uncooked sausage, scalded sausage, cooked sausage, cooked cured article, uncooked cured article, aspic and jellied meat.
b) producing and/or providing (i) at least partially fermented fermented meat, or (ii) an extract, a solution or a suspension of at least partially fermented meat, wherein the meat is or was fermented under at least partially aerobic conditions, and under conditions at which the relative air humidity of the ambient atmosphere is below the associated a_{w} value for the meat to be fermented, and the fermentation takes or took place under addition of a starter culture,
c) if the ingredients of a food were provided in step a), producing the food and
d)i) admixing the food with (i) the at least partially fermented fermented meat, or (ii) the extract, the solution or the suspension of at least partially fermented meat, or
d)ii) if the ingredients of a food were provided in step a), mixing (i) the at least partially fermented meat, or (ii) the extract, the solution or the suspension of at least partially fermented meat, with the ingredients of the food before step c),
with the result that a food as claimed in claim 1 is formed.

8. The method as claimed in claim 7, wherein minced fermented meat is used in step d).

9. The method as claimed in claim 7, wherein an aqueous, ethanolic or oily extract or an aqueous suspension of fermented meat is used in step d).

10. The method as claimed in claim 7, wherein the extract, the solution or the suspension of the at least partially fermented meat is injected in step d)i).

11. The method as claimed in claim 7, wherein the starter culture comprises a microorganism selected from the group consisting of Enterococcus sp., Kocuria sp., Micrococcus sp., Streptomyces sp., Tetragenococcus sp., Candida sp., Citeromyces sp., Cryptococcus sp. (noninfectious), Cystofilobasidium sp., Debaryomyces sp., Galactomyces sp., Geotrichum sp., Hanseniaspora sp., Hansenula sp., Hypopichia sp., Issatchenkia sp., Kluyveromyces sp., Metschnikowia sp., Pichia sp., Rhodosporidium sp., Rhodotorula sp., Saccharomyces sp., Sporobolomyces sp Sterigmatomyces sp., Torulaspora sp., Trichosporon sp., Torulopsis sp., Yarrowia sp., Acremonium sp., Actinomucor sp., Amylomyces rouxii, Aspergillus sp., Aureobasidium pullulans (Pullularia pullulans), Cystofilobasidium infirmominiatum, Eurotium rubrum, Guehomyces pullulans, Monascus sp., Mucor sp., Neurospora intermedia, Neurospora sitophila, Penicillium sp., Rhizopus sp., Talaromyces sp., Thamnidium sp., Terfezia sp. and Tuber sp.

12. The food as claimed in claim 1, wherein the food is a meat product.

13. The food as claimed in claim 1, wherein the food is a meat product selected from the group consisting of meat preparation, uncooked sausage, scalded sausage, cooked sausage, cooked cured article, uncooked cured article, aspic and jellied meat.

14. The food as claimed in claim 1, wherein (i) the at least partially fermented meat or (ii) the extract of the at least partially meat of animal origin is distributed across the entire cross-section of the food.
